(19) United States
(12) Patent Application Publication
(10) Pub. No.: US 2026/0093214 A1
(43) Pub. Date: Apr. 2, 2026

(54) SYSTEMS AND METHODS FOR ENSURING INTEGRITY OF OIL AND GAS WELL INTERVENTION OPERATIONS USING BLOCKCHAIN TECHNOLOGIES

(71) Applicant: SCHLUMBERGER TECHNOLOGY CORPORATION, Sugar Land, TX (US)

(72) Inventors: William BROUWER, Sugar Land, TX (US); Nikolai VODNIKOV, Sugar Land, TX (US); Pavel SPESIVTSEV, Houston, TX (US); Pierre RAMONDENC, Petaling Jaya (MY); Samir MENASRIA, Sugar Land, TX (US); Richard CHRISTIE, Sugar Land, TX (US)

(21) Appl. No.: 19/111,331

(22) PCT Filed: Sep. 13, 2023
(86) PCT No.: PCT/US2023/032598

§ 371 Date: Mar. 13, 2025

Related U.S. Application Data
(60) Provisional application No. 63/375,867, filed on Sep. 16, 2022.

(51) Int. Cl. G05B 13/04; E21B 44/00

(52) U.S. Cl. CPC G05B 13/042; E21B 44/00

(57) ABSTRACT

Systems and methods presented herein facilitate ensuring the integrity of oil and gas well intervention operations using blockchain technologies. In particular, the systems and methods described herein utilize blockchain technologies to ensure that all data relating to oil and gas well intervention operations are captured and stored in substantially real time during the operations in a secure and immutable manner.

### CROSS REFERENCE PARAGRAPH

This application claims the benefit of U.S. Provisional Application No. 63/375,867 entitled “SYSTEMS AND METHODS FOR ENSURING INTEGRITY OF OIL AND GAS WELL INTERVENTION OPERATIONS USING BLOCKCHAIN TECHNOLOGIES,” filed Sep. 16, 2022, the disclosure of which is hereby incorporated herein by reference.

### BACKGROUND

The present disclosure generally relates to systems and methods for ensuring the integrity of oil and gas well intervention operations using blockchain technologies.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

In many well applications, coiled tubing is employed to facilitate performance of many types of downhole operations. Coiled tubing offers versatile technology due in part to its ability to pass through completion tubulars while conveying a wide array of tools downhole. An oil and gas well intervention system may include many systems and components, including a coiled tubing reel, an injector head, a gooseneck, lifting equipment (e.g., a mast or a crane), and other supporting equipment such as pumps, treating irons, or other components. Coiled tubing has been utilized for performing well treatment and/or well intervention operations in existing wellbores such as hydraulic fracturing operations, matrix acidizing operations, milling operations, perforating operations, coiled tubing drilling operations, and various other types of oil and gas well intervention operations.

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include a method that may include receiving, via a data processing and control system, data relating to operational parameters of an oil and gas well intervention operation. The method may also include storing, via the data processing and control system, the data relating to the operational parameters of the oil and gas well intervention operation in a blockchain network.

Certain embodiments of the present disclosure also include a system that includes a data processing and control system configured to receive data relating to operational parameters of an oil and gas well intervention operation. The data processing and control system is also configured to store the data relating to the operational parameters of the oil and gas well intervention operation in a blockchain network.

Certain embodiments of the present disclosure also include a tangible non-transitory computer-readable media comprising process-executable instructions that, when executed by one or more processors, cause the one or more processors to receive data relating to operational parameters of an oil and gas well intervention operation, and to store the data relating to the operational parameters of the oil and gas well intervention operation in a blockchain network.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings, in which:

FIG. 1 is a schematic illustration of an oil and gas well intervention operation using a coiled tubing system, in accordance with embodiments of the present disclosure;

FIG. 2 illustrates a well control system that may include a data processing and control system to control the oil and gas well intervention system of FIG. 1, in accordance with embodiments of the present disclosure;

FIG. 3 illustrates a blockchain-based oil and gas well intervention analysis service, in accordance with embodiments of the present disclosure;

FIG. 4 illustrates a blockchain framework of the blockchain-based oil and gas well intervention analysis service illustrated in FIG. 3, in accordance with embodiments of the present disclosure;

FIG. 5 illustrates a blockchain of the blockchain framework illustrated in FIG. 4, in accordance with embodiments of the present disclosure; and

FIG. 6 is a flow diagram of a process for operating a data processing and control system, in accordance with embodiments of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole”, “upper” and “lower,” “top” and “bottom,” and other like terms indicating relative positions to a given point or element are utilized to more clearly describe some elements. Commonly, these terms relate to a reference point as the surface from which drilling operations are initiated as being the top (e.g., uphole or upper) point and the total depth along the drilling axis being the lowest (e.g., downhole or lower) point, whether the well (e.g., wellbore, borehole) is vertical, horizontal or slanted relative to the surface.

As used herein, a fracture shall be understood as one or more cracks or surfaces of breakage within rock. Fractures can enhance permeability of rocks greatly by connecting pores together and, for that reason, fractures can be induced mechanically in some reservoirs in order to boost hydrocarbon flow. Certain fractures may also be referred to as natural fractures to distinguish them from fractures induced as part of a reservoir stimulation. Fractures can also be grouped into fracture clusters (or “perf clusters”) where the fractures of a given fracture cluster (perf cluster) connect to the wellbore through a single perforated zone. As used herein, the term “fracturing” refers to the process and methods of breaking down a geological formation and creating a fracture (i.e., the rock formation around a well bore) by pumping fluid at relatively high pressures (e.g., pressure above the determined closure pressure of the formation) in order to increase production rates from a hydrocarbon reservoir.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic” and “automated” are intended to describe operations that are performed or caused to be performed, for example, by a processing/control system (i.e., solely by the processing/control system, without human intervention).

The embodiments described herein generally include systems and methods that facilitate operation of well-related tools. In certain embodiments, a variety of data (e.g., downhole data and/or surface data) may be collected to enable optimization of operations related to the well-related tools. In certain embodiments, the collected data may be provided as advisory data (e.g., presented to human operators of the well to inform control actions performed by the human operators) and/or used to facilitate automation of downhole processes and/or surface processes (e.g., which may be automatically performed by a computer implemented data processing and control system (e.g., a well control system), without intervention from human operators).

In certain embodiments, the systems and methods described herein may enhance downhole oil and gas well intervention operations by improving the efficiency and utilization of data to enable performance optimization and improved resource controls of the downhole oil and gas well intervention operations. In certain embodiments, a downhole well tool may be deployed downhole into a wellbore via coiled tubing. In certain embodiments, the systems and methods described herein may be used for displaying or otherwise outputting desired (e.g., optimal) actions to human operators so as to enable improved decision-making regarding operation of the well tool (e.g., operation of a downhole or surface system/device).

In certain embodiments, downhole parameters are obtained via, for example, downhole sensors while the downhole well tool is disposed in the wellbore. In certain embodiments, the downhole parameters may be obtained by the downhole sensors in substantially real time (e.g., as the downhole data is detected while the downhole well tool is being operated) and sent to the data processing and control system (or other suitable processing system) via wired or wireless telemetry. The downhole parameters may be combined with surface parameters. In certain embodiments, the downhole and/or surface parameters may be processed during operation of the well tool downhole to enable automatic optimization (e.g., by the data processing and control system, without human intervention) with respect to the operation of the well tool during subsequent stages of well tool operation.

The embodiments described herein provide systems and methods for ensuring that the state of oil and gas well intervention equipment, such as coiled tubing strings, is accurately stored and tracked with relevant data that contributes to the state including, but not limited to, operating conditions such as accumulated fatigue, pressure, depth of operations, chemical treatments, and more as dictated by the particular application. In particular, blockchain technologies have become ubiquitous for many applications such as facilitating decentralized digital currencies including bitcoin and Ethereum. The embodiments described herein utilize such blockchain technologies to ensure that all data relating to operations of oil and gas well intervention systems are captured and stored in substantially real time during the operations in a secure and immutable manner.

The success of oil and gas well intervention operations is very much dependent upon accurately tracking coiled tubing pipe fatigue damage in order to prevent catastrophic events that can lead to significant financial and other losses. To date, these events are largely avoided by taking a very conservative approach and replacing coiled tubing pipe well before failures occur. However, the current process of storing and transmitting oil and gas well intervention data between different jobs involves multiple machines, assisted by different users and files whose provenance is not always clear and, further, may not necessarily capture all the processes applied during a particular oil and gas well intervention operation.

Blockchain technologies have become a proven option for transmitting transactional information in a secure manner across a distributed network that is highly fault tolerant and secure. The success of blockchain technologies is founded upon several principles including the extreme complexity in forging or otherwise corrupting data added to the blockchain (i.e., the blocks), but also the resiliency of a distributed network, which can be an important feature for oil and gas well intervention operations where network quality is poor or even non-existent. The embodiments described herein store data in one or more blockchains, wherein the data includes inputs and outputs relating to coiled tubing pipe data, as well as operational details including acquisition data, applied treatments, and any other pertinent information.

Each time coiled tubing pipe is used, the coiled tubing pipe life is consumed or spent, analogous to a financial transaction, the type of data traditionally stored using blockchain. The amount of consumed coiled tubing pipe life, or accumulated fatigue, can be evaluated either from physics-based models, data analytics approach, from direct measurements, or from a combination of these and other approaches. The fatigue information should be stored and updated for the coiled tubing pipe as it is used during different operations and well intervention types throughout its life until it is decommissioned. It is known that the coiled tubing pipe may also be stored on a coiled tubing reel in between operations for extended periods of time of inactivity. While being stored, the coiled tubing pipe may also experience passive damage that can be expressed as an addition to accumulated fatigue from active operations. Active intervention operations, storage, maintenance on the pipe (e.g., trimming it or cutting substantial sections of pipe, or even spooling the pipe on another reel to swap the end exposed to downhole conditions) and other events, such as exposure of the coiled tubing pipe to corrosive fluids, constitute certain periods in the life of coiled tubing pipe. Therefore, it is important to securely and reliably store the accumulated fatigue data of coiled tubing pipe at the end of each such periods, and then transmit this data as starting point data to the subsequent period of the coiled tubing pipe life. As described in greater detail herein, this can be achieved by using a data processing/control system connected to a blockchain network.

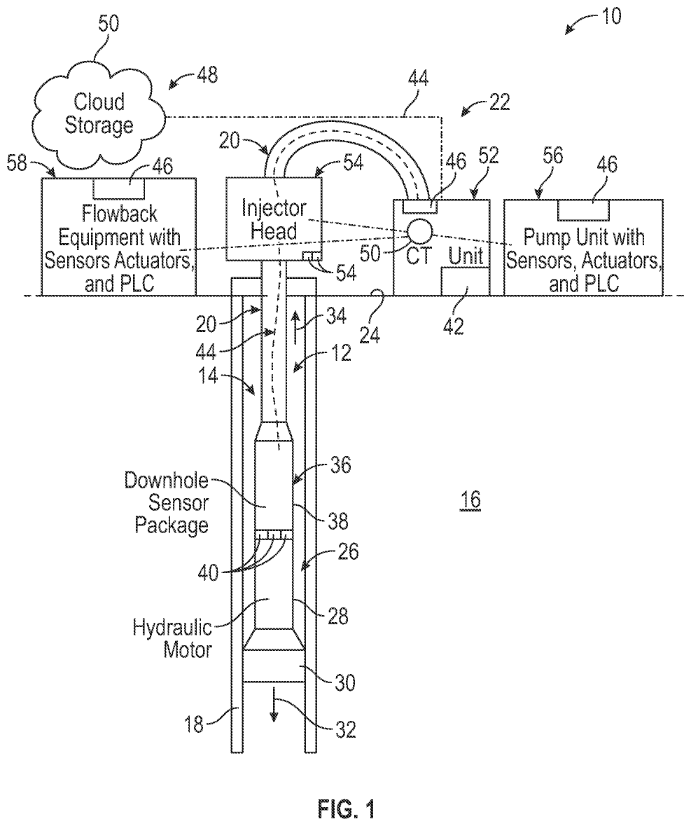

The same approach can be used to track the total operational time, operational events, maintenance events (e.g., on the pipe or other pieces of tracked equipment during and in between well interventions), and other activities associated with other equipment involved in the typical oil and gas well intervention operation as per FIG. 1. In other words, although primarily described herein as being directed towards determining the fatigue life of coiled tubing during oil and gas well intervention operations, the techniques described herein may also be extended to the determination of fatigue life of other types of equipment used in various types of oil and gas well intervention operations, which may also experience diminishing life. For example, in other embodiments, the fatigue life of various components or sub-components of a bottom hole assembly (“BHA”) may be determined in a similar manner as for the coiled tubing pipe described herein.

Another advantage of blockchain technologies is that it is virtually computationally impossible to alter the history, a feature which eliminates the possibility of ‘double spend’, a significant feature of cryptocurrency. Similarly, it is expected that using blockchain technologies to store all relevant details of coiled tubing pipe history will eliminate the possibility of coiled tubing pipe or other oil and gas well intervention equipment overuse. In addition to avoiding failures by making the process of tracking vital information more secure, distributed and less error prone, the embodiments described herein allow for cost reduction where confidence in data provenance can be guaranteed.

With the foregoing in mind, FIG. 1 is a schematic illustration of an oil and gas well intervention operation 10 using a coiled tubing system. As illustrated, in certain embodiments, a coiled tubing string 12 may be run into a wellbore 14 that traverses a hydrocarbon-bearing reservoir 16. While certain elements of the oil and gas well intervention operation 10 are illustrated in FIG. 1, other elements of the well (e.g., blow-out preventers, wellhead “tree”, etc.) have been omitted for clarity of illustration. In certain embodiments, the oil and gas well intervention operation 10 includes an interconnection of pipes, including vertical and/or horizontal casings 18, coiled tubing 20, and so forth, that connect to a surface facility 22 at the surface 24 of the oil and gas well intervention operation 10. In certain embodiments, the coiled tubing 20 extends inside the casing 18 and terminates at a tubing head (not shown) at or near the surface 24. In addition, in certain embodiments, the casing 18 contacts the wellbore 14 and terminates at a casing head (not shown) at or near the surface 24.

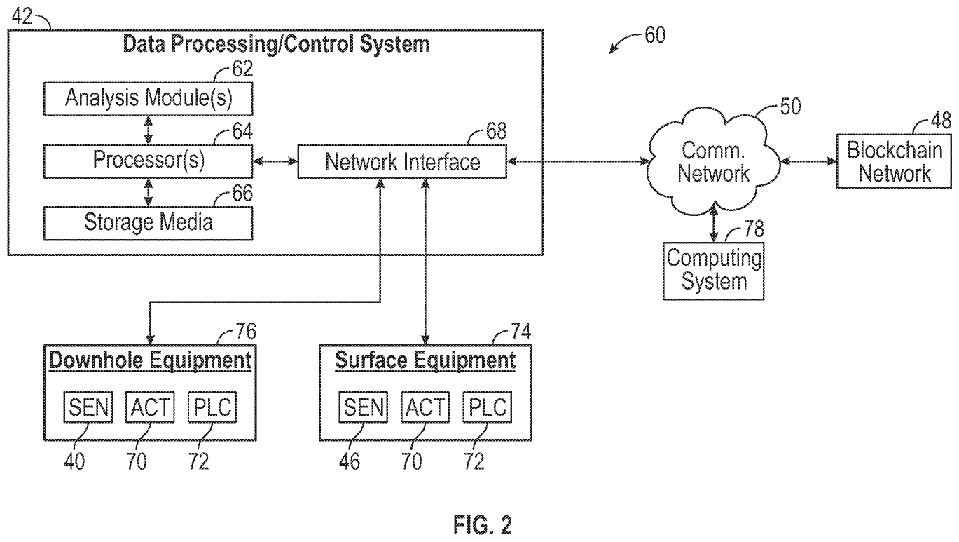

In certain embodiments, a BHA 26 may be run inside the casing 18 by the coiled tubing 20. As illustrated in FIG. 2, in certain embodiments, the BHA 26 may include a downhole motor 28 that operates to rotate a bit 30 (e.g., a drilling bit during drilling operations, a milling bit during milling operations, and so forth) or other downhole tool. In certain embodiments, the downhole motor 28 may be driven by hydraulic forces carried in fluid supplied from the surface 24 of the oil and gas well intervention operation 10. In certain embodiments, the BHA 26 may be connected to the coiled tubing 20, which is used to run the BHA 26 to a desired location within the wellbore 14. It is also contemplated that, in certain embodiments, the rotary motion of the bit 30 may be driven by rotation of the coiled tubing 20 effectuated by a rotary table or other surface-located rotary actuator. In such embodiments, the downhole motor 28 may be omitted.

In certain embodiments, the coiled tubing 20 may also be used to deliver fluid 32 to the bit 30 through an interior of the coiled tubing 20 to aid in the drilling or milling process and carry cuttings and possibly other fluid and solid components in return fluid 34 that flows up the annulus between the coiled tubing 20 and the casing 18 (or via a return flow path provided by the coiled tubing 20, in certain embodiments) for return to the surface facility 22. It is also contemplated that the return fluid 34 may include remnant proppant (e.g., sand) or possibly rock fragments that result from a hydraulic fracturing application, and flow within the oil and gas well intervention operation 10. Under certain conditions, fracturing fluid and possibly hydrocarbons (oil and/or gas), proppants and possibly rock fragments may flow from the fractured reservoir 16 through perforations in a newly opened interval and back to the surface 24 of the oil and gas well intervention operation 10 as part of the return fluid 34. In certain embodiments, the BHA 26 may be supplemented behind the rotary drill by an isolation device such as, for example, an inflatable packer that may be activated to isolate the zone below or above it, and enable local pressure tests.

As such, in certain embodiments, the oil and gas well intervention operation 10 may include a downhole well tool 36 that is moved along the wellbore 14 via the coiled tubing 20. In certain embodiments, the downhole well tool 36 may include a variety of drilling/milling/cutting tools coupled with the coiled tubing 20 to provide a coiled tubing string 12. In the illustrated embodiment, the downhole well tool 36 includes a bit 30, which may be powered by a motor 28 (e.g., a positive displacement motor (PDM), or other hydraulic motor) of a BHA 26. In certain embodiments, the wellbore 14 may be an open wellbore or a cased wellbore defined by a casing 18. In addition, in certain embodiments, the wellbore 14 may be vertical or horizontal or inclined. It should be noted the downhole well tool 36 may be part of various types of BHAs 26 coupled to the coiled tubing 20.

As also illustrated in FIG. 1, in certain embodiments, the oil and gas well intervention operation 10 may include a downhole sensor package 38 having a plurality of downhole sensors 40. In certain embodiments, the sensor package 38 may be mounted along the coiled tubing string 12, although certain downhole sensors 40 may be positioned at other downhole locations in other embodiments. In certain embodiments, data from the downhole sensors 40 may be relayed uphole to a data processing and control system 42 (e.g., a computer-based processing system) disposed at the surface 24 and/or other suitable location of the oil and gas well intervention operation 10. In certain embodiments, the data may be relayed uphole in substantially real time (e.g., relayed while it is detected by the downhole sensors 40 during operation of the downhole well tool 36) via a wired or wireless telemetric control line 44, and this real-time data may be referred to as edge data. In certain embodiments, the telemetric control line 44 may be in the form of an electrical line, fiber optic line, or other suitable control line for transmitting data signals. In addition, in certain embodiments, the telemetric control line 44 (e.g., a fiber optic cable) itself may acquire data that relayed uphole. In certain embodiments, the telemetric control line 44 may be routed along an interior of the coiled tubing 20, within a wall of the coiled tubing 20, or along an exterior of the coiled tubing 20. In addition, as described in greater detail herein, the data collected by the data processing and control system 42 may be stored in a distributed blockchain network 48 via communication through a communication network 50.

As illustrated, in certain embodiments, the coiled tubing 20 may deployed by a coiled tubing unit 52 and delivered downhole via an injector head 54. In certain embodiments, the injector head 54 may be controlled to slack off or pick up on the coiled tubing 20 so as to control the tubing string weight and, thus, the weight on bit (WOB) acting on the bit 30 (or other downhole well tool 36). In certain embodiments, the downhole well tool 36 may be moved along the wellbore 14 via the coiled tubing 20 under control of the injector head 54 so as to apply a desired tubing weight and, thus, to achieve a desired rate of penetration (ROP) as the bit 30 is operated. Depending on the specifics of a given application, various types of data may be collected downhole, and transmitted to the data processing and control system 42 in substantially real time to facilitate improved operation of the downhole well tool 36. For example, the data may be used to fully or partially automate the downhole operation, to optimize the downhole operation, and/or to provide more accurate predictions regarding components or aspects of the downhole operation.

In certain embodiments, fluid 32 may be delivered downhole under pressure from a pump unit 56. In certain embodiments, the fluid 32 may be delivered by the pump unit 56 through the downhole hydraulic motor 28 to power the downhole hydraulic motor 28 and, thus, the bit 30. In certain embodiments, the return fluid 34 is returned uphole, and this flow back of return fluid 34 is controlled by suitable flowback equipment 58. In certain embodiments, the flowback equipment 58 may include chokes and other components/equipment used to control flow back of the return fluid 34 in a variety of applications, including well treatment applications.

As described in greater detail herein, the pump unit 56 and the flowback equipment 58 may include advanced sensors, actuators, and local controllers, such as PLCs, which may cooperate together to provide sensor data to, receive control signals from, and generate local control signals based on communications with, respectively, the data processing and control system 42. In certain embodiments, as described in greater detail herein, the sensors may include flow rate, pressure, and fluid rheology sensors, among other types of sensors. In addition, as described in greater detail herein, the actuators may include actuators for pump and choke control of the pump unit 56 and the flowback equipment 58, respectively, among other types of actuators.

In addition, as described in greater detail herein, the data that is collected by the data processing and control system 42 may be stored in a distributed blockchain network so that the data processing and control system 42 and/or other computing systems may have continuous access to the data to enable the data processing and control system 42 and/or other computing systems to ensure the integrity of operations performed by the oil and gas well intervention operation 10. By utilizing a distributed blockchain network to store such oil and gas well intervention operational data, as described in greater detail herein, the analysis of the oil and gas well intervention operations performed by the data processing and control system 42 and/or other computing systems may be relatively more secure, reliable, and immutable, thereby further enhancing the effectiveness of the operations.

Again, although primarily described herein as being directed towards determining the fatigue life of coiled tubing 20 during oil and gas well intervention operations, the techniques described herein may also be extended to the determination of fatigue life of other types of equipment used in various types of oil and gas well intervention operations, which may also experience diminishing life. For example, in other embodiments, the fatigue life of various components or sub-components of the BHA described herein may be determined in a similar manner as for the coiled tubing 20 described herein.

FIG. 2 illustrates a well control system 60 that may include the data processing and control system 42 to control the oil and gas well intervention operation 10 described herein. In certain embodiments, the data processing and control system 42 may include one or more analysis modules 62 (e.g., a program of computer-executable instructions and associated data) that may be configured to perform various functions of the embodiments described herein. In certain embodiments, to perform these various functions, an analysis module 62 executes on one or more processors 64 of the data processing and control system 42, which may be connected to one or more storage media 66 of the data processing and control system 42. Indeed, in certain embodiments, the one or more analysis modules 62 may be stored in the one or more storage media 66.

In certain embodiments, the one or more processors 64 may include a microprocessor, a microcontroller, a processor module or subsystem, a programmable integrated circuit, a programmable gate array, a digital signal processor (DSP), or another control or computing device. In certain embodiments, the one or more storage media 66 may be implemented as one or more non-transitory computer-readable or machine-readable storage media. In certain embodiments, the one or more storage media 66 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the computer-executable instructions and associated data of the analysis module(s) 62 may be provided on one computer-readable or machine-readable storage medium of the storage media 66, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 66 may be located either in the machine running the machine-readable instructions, or may be located at a remote site from which machine-readable instructions may be downloaded over a network for execution.

In certain embodiments, the processor(s) 64 may be connected to a network interface 68 of the data processing and control system 42 to allow the data processing and control system 42 to communicate with the various downhole sensors 40 and surface sensors 46 described herein, as well as communicate with the actuators 70 and/or PLCs 72 of the surface equipment 74 (e.g., the coiled tubing unit 52, the pump unit 56, the flowback equipment 58, and so forth) and of the downhole equipment 76 (e.g., the BHA 26, the downhole motor 28, the bit 30, the downhole well tool 36, and so forth) for the purpose of controlling operation of the oil and gas well intervention operation 10, as described in greater detail herein. In certain embodiments, the network interface 68 may also facilitate the data processing and control system 42 to communicate data through a suitable wired and/or wireless communication network 50 to, for example, archive the data and/or to enable external computing systems 78 to access the data. In addition, as described in greater detail herein, the data processing and control system 42 and/or external computing systems 78 may be configured to communicate with a distributed blockchain network 48 so that the data described herein may be stored in (and retrieved from) the blockchain network 48 a relatively more secure, reliable, and immutable manner. When locations engaged in oil and gas well intervention operations are not connected to the internet, new blocks created during operations comprised of vital data, such as accumulated fatigue and operating conditions, are added to the blockchain during periods of re-connection to the internet. In complete analogy with blockchain applied to cryptocurrency, should a concurrent block be created either deliberately or accidentally by another party for the same coiled tubing string, then only the block with highest score (i.e., accumulated fatigue) will be added to the main chain.

It should be appreciated that the well control system 60 illustrated in FIG. 2 is only one example of a well control system, and that the well control system 60 may have more or fewer components than shown, may combine additional components not depicted in the embodiment of FIG. 2, and/or the well control system 60 may have a different configuration or arrangement of the components depicted in FIG. 2. In addition, the various components illustrated in FIG. 2 may be implemented in hardware, software, or a combination of both hardware and software, including one or more signal processing and/or application specific integrated circuits. Furthermore, the operations of the well control system 60 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

As described in greater detail herein, the embodiments described herein facilitate the operation of well-related tools. For example, a variety of data (e.g., downhole data and surface data) may be collected to enable optimization of operations of well-related tools such as the downhole well tool 36 illustrated in FIG. 1 by the data processing and control system 42 illustrated in FIG. 2 (or other suitable processing system). In certain embodiments, the data may be provided as advisory data by the data processing and control system 42 (or other suitable processing system). However, in other embodiments, the data may be used to facilitate automation of downhole processes and/or surface processes (i.e., the processes may be automated without human intervention), as described in greater detail herein, by the data processing and control system 42 (or other suitable processing system). The embodiments described herein may enhance downhole operations by improving the efficiency and utilization of data to enable performance optimization and improved resource controls.

In particular, as described in greater detail herein, downhole parameters may be obtained via, for example, downhole sensors 40 while the downhole well tool 36 is disposed within the wellbore 14. In certain embodiments, the downhole parameters may be obtained in substantially real-time and sent to the data processing and control system 42 via wired or wireless telemetry. In certain embodiments, downhole parameters may be combined with surface parameters by the data processing and control system 42. In certain embodiments, the downhole and surface parameters may be processed by the data processing and control system 42 during use of the downhole well tool 36 to enable automatic (e.g., without human intervention) optimization with respect to use of the downhole well tool 36 during subsequent stages of operation of the downhole well tool 36.

Examples of downhole parameters that may be sensed in real time include, but are not limited to, weight on bit (WOB), torque acting on the downhole well tool 36, downhole pressures, downhole differential pressures, and other desired downhole parameters. In certain embodiments, downhole parameters may be used by the data processing and control system 42 in combination with surface parameters, and such surface parameters may include, but are not limited to, pump-related parameters (e.g., pump rate and circulating pressures of the pump unit 56). In certain embodiments, the surface parameters also may include parameters related to fluid returns (e.g., wellhead pressure, return fluid flow rate, choke settings, amount of proppant returned, and other desired surface parameters). In certain embodiments, the surface parameters also may include data from the coiled tubing unit 52 (e.g., surface weight of the coiled tubing string 12, speed of the coiled tubing 20, rate of penetration, and other desired parameters). In certain embodiments, the surface data that may be processed by the data processing and control system 42 to optimize performance also may include previously recorded data such as fracturing data (e.g., close-in pressures from each fracturing stage, proppant data, friction data, fluid volume data, and other desired data).

In certain embodiments, depending on the type of downhole operation, the downhole data and surface data may be combined and processed by the data processing and control system 42 to prevent stalls and to facilitate stall recovery with respect to the downhole well tool 36. In addition, in certain embodiments, processing of the downhole and surface data by the data processing and control system 42 may also facilitate cooperative operation of the coiled tubing unit 52, the pump unit 56, the flowback equipment 58, and so forth. This cooperation provides synergy that facilitates output of advisory information and/or automation of the downhole process, as well as appropriate adjustment of the rate of penetration (ROP) and pump rates for each individual stage of the operation, by the data processing and control system 42. It should be noted that the data (e.g., downhole data and surface data) also may be used by the data processing and control system 42 to provide advisory information and/or automation of surface processes, such as pumping processes performed by the coiled tubing unit 52, the pump unit 56, the flowback equipment 58, and so forth.

In certain embodiments, use of this data enables the data processing and control system 42 to self-learn to provide, for example, optimum downhole WOB and torque in an efficient manner. This real-time modeling by the data processing and control system 42, based on the downhole and surface parameters, enables improved prediction of WOB, torque, and pressure differentials. Such modeling by the data processing and control system 42 also enables the downhole process to be automated and automatically optimized by the data processing and control system 42. The downhole parameters also may be used by the data processing and control system 42 to predict wear on the downhole motor 28 and/or the bit 30, and to advise as to timing of the next trip to the surface for replacement of the downhole motor 28 and/or the bit 30.

The downhole parameters also enable use of pressures, temperatures, or even fluid velocities to be used by the data processing and control system 42 in characterizing the reservoir 16. Such real-time downhole parameters also enable use of pressures, temperatures, or fluid velocities by the data processing and control system 42 for in situ evaluation and advisory of post-fracturing flow back parameters, and for creating an optimum flow back schedule for maximized production of, for example, hydrocarbon fluids from the surrounding reservoir 16. The data available from a given well may be utilized in designing the next fracturing schedule for the same pad/neighbor wells as well as predictions regarding subsequent wells.

For example, downhole data such as WOB, torque data from a load module associated with the downhole well tool 36, and bottom hole pressures (internal and external to the bottom hole assembly 26/downhole well tool 36) may be processed via the data processing and control system 42. This processed data may then be employed by the data processing and control system 42 to control the injector head 54 to generate, for example, a faster and more controlled ROP. Additionally, the data may be updated by the data processing and control system 42 as the downhole well tool 36 is moved to different positions along the wellbore 14 to help optimize operations. The data also enables automation of the downhole process through automated controls over the injector head 54 via control instructions provided by the data processing and control system 42.

In certain embodiments, data from downhole may be combined by the data processing and control system 42 with surface data received from injector head 54 and/or other measured or stored surface data. By way of example, surface data may include hanging weight of the coiled tubing string 12, speed of the coiled tubing 20, wellhead pressure, choke and flow back pressures, return pump rates, circulating pressures (e.g., circulating pressures from the manifold of a coiled tubing reel in the coiled tubing unit 52), and pump rates. The surface data may be combined with the downhole data by the data processing and control system 42 with in real time to provide an automated system that self-controls the injector head 54. For example, the injector head 54 may be automatically controlled (e.g., without human intervention) to optimize ROP under direction from the data processing and control system 42.

In certain embodiments, data from drilling parameters (e.g., surveys and pressures) as well as fracturing parameters (e.g., volumes and pressures) may be combined with real-time data obtained from sensors 40, 46. The combined data may be used by the data processing and control system 42 in a manner that aids in machine learning (e.g., artificial intelligence) to automate subsequent jobs in the same well and/or for neighboring wells. The accurate combination of data and the updating of that data in real time helps the data processing and control system 42 improve the automatic performance of subsequent tasks.

In certain embodiments, depending on the type of operation downhole, the data processing and control system 42 may be programmed with a variety of algorithms and/or modeling techniques to achieve desired results. For example, the downhole data and surface data may be combined and at least some of the data may be updated in real time by the data processing and control system 42. This updated data may be processed by the data processing and control system 42 via suitable algorithms to enable automation and to improve the performance of, for example, downhole well tool 36. By way of example, the data may be processed and used by the data processing and control system 42 for preventing motor stalls. In certain embodiments, downhole parameters such as forces, torque, and pressure differentials may be combined by the data processing and control system 42 to enable prediction of a next stall of the downhole motor 28 and/or to give a warning to a supervisor. In such embodiments, the data processing and control system 42 may be programmed to make self-adjustments (e.g., automatically, without human intervention) to, for example, speed of the injector head 54 and/or pump pressures to prevent the stall, and to ensure efficient continuous operation.

In addition, in certain embodiments, the data and the ongoing collection of data may be used by the data processing and control system 42 to monitor various aspects of the performance of downhole motor 28. For example, motor wear may be detected by monitoring the effective torque of the downhole motor 28 based on data obtained regarding pump rates, pressure differentials, and actual torque measurements of the downhole well tool 36. Various algorithms may be used by the data processing and control system 42 to help a supervisor on site to predict, for example, how many more hours the downhole motor 28 may be run efficiently. This data, and the appropriate processing of the data, may be used by the data processing and control system 42 to make automatic decisions or to provide indications to a supervisor as to when to pull the coiled tubing string 12 to the surface to replace the downhole motor 28, the bit 30, or both, while avoiding unnecessary trips to the surface.

In certain embodiments, downhole data and surface data also may be processed via the data processing and control system 42 to predict when the coiled tubing string 12 may become stuck. The ability to predict when the coiled tubing string 12 may become stuck helps avoid unnecessary short trips and, thus, improves coiled tubing pipe longevity. In certain embodiments, downhole parameters such as forces, torque, and pressure differentials in combination with surface parameters such as weight of the coiled tubing 20, speed of the coiled tubing 20, pump rate, and circulating pressure may be processed via the data processing and control system 42 to provide predictions as to when the coiled tubing 20 will become stuck.

In certain embodiments, the data processing and control system 42 may be designed to provide warnings to a supervisor and/or to self-adjust (e.g., automatically, without human intervention) either the speed of the injector head 54, the pump pressures and rates of the pump unit 56, or a combination of both, so as to prevent the coiled tubing 20 from getting stuck. By way of example, the warnings or other information may be output to a display of the data processing and control system 42 to enable an operator to make better, more informed decisions regarding downhole or surface processes related to operation of the downhole well tool 36. In certain embodiments, the speed of the injector head 54 may be controlled via the data processing and control system 42 by controlling the slack-off force from the surface. In general, the ability to predict and prevent the coiled tubing 20 from becoming stuck substantially improves the overall efficiency and helps avoid unnecessary short trips if the probability of the coiled tubing 20 getting stuck is minimal. Accordingly, the downhole data and surface data may be used by the data processing and control system 42 to provide advisory information and/or automation of surface processes, such as pumping processes or other processes.

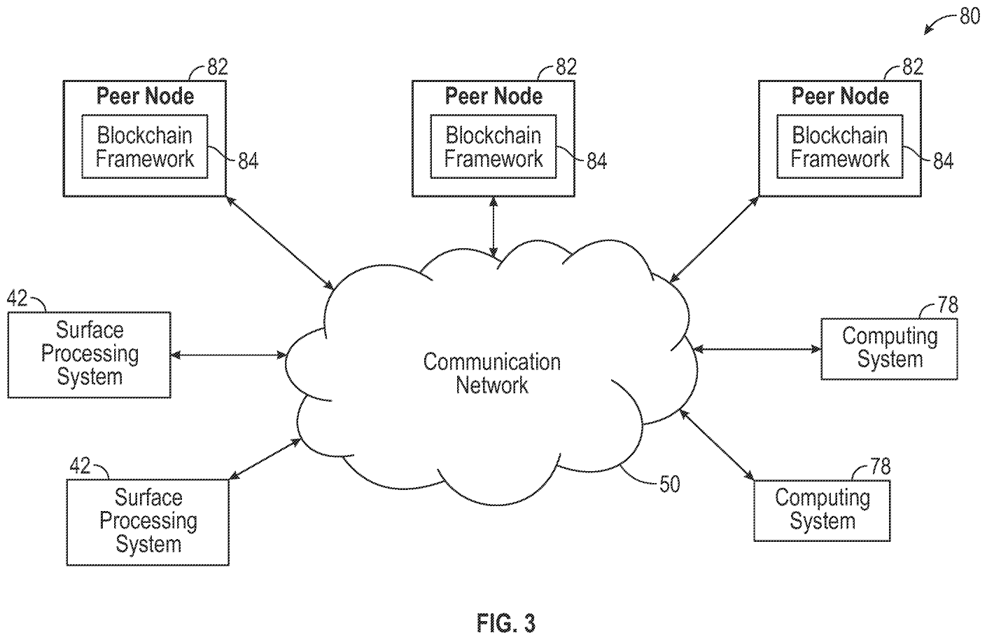

FIG. 3 illustrates a blockchain-based oil and gas well intervention analysis service 80 that may be implemented utilizing a plurality of peer nodes 82 of a blockchain network 48 that are accessible by a plurality of data processing and control systems 42 and/or other computing systems 78 through one or more communication networks 50. A blockchain framework 84 may be resident in each peer node 82 to maintain and execute smart contracts, for example. In certain embodiments, the peer nodes 82 may be managed by a cloud-based collaboration system and/or each data processing and control system 42, for example. In certain embodiments, a few dedicated peer nodes 82 configured to store smart contracts related to a particular entity may be utilized. Each peer node 82 may also be leveraged to store data and, based on smart contract details, a private subnet may be setup between associated peer nodes 82 in order to enable private and secured communications. In the context of the present disclosure, the creation of a smart contract may correspond to an action taken by an operator working in the field, whereupon at the point of job completion and when all pertinent details relevant to dictating the extent to which the life of coiled tubing has diminished are available for incorporation into the distributed blockchain. Details relevant to the deterioration of the coiled tubing during operations (i.e., components of the smart contract) include, but are not limited to, the presence and action of corrosive agents, details recorded in a spreadsheet, including chemical composition and duration of exposure. Other components of the smart contract may include a text file of acquisition data recorded throughout the oil and gas well intervention operation and applied in the calculation of accumulated fatigue, as well as a text file record of the coiled tubing string properties themselves including, but not limited to, materials properties, welding, and reel information.

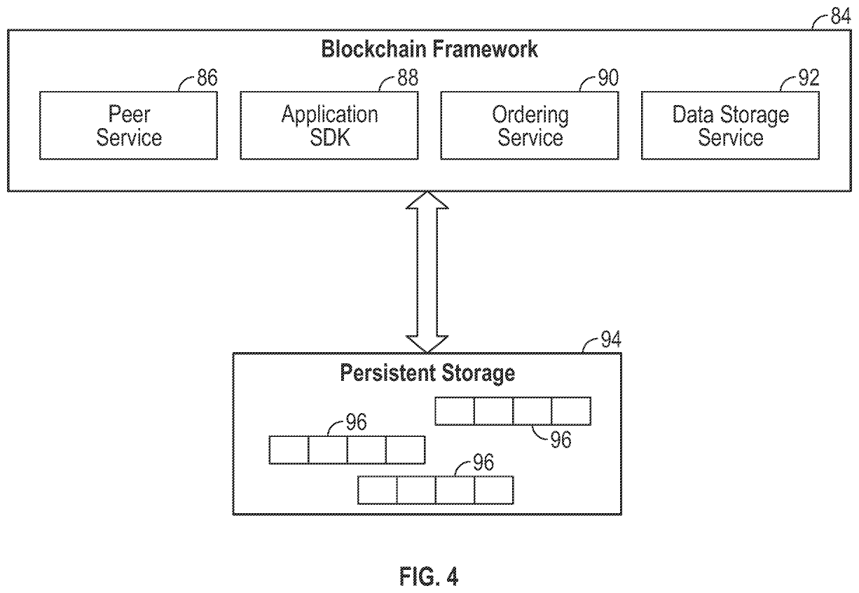

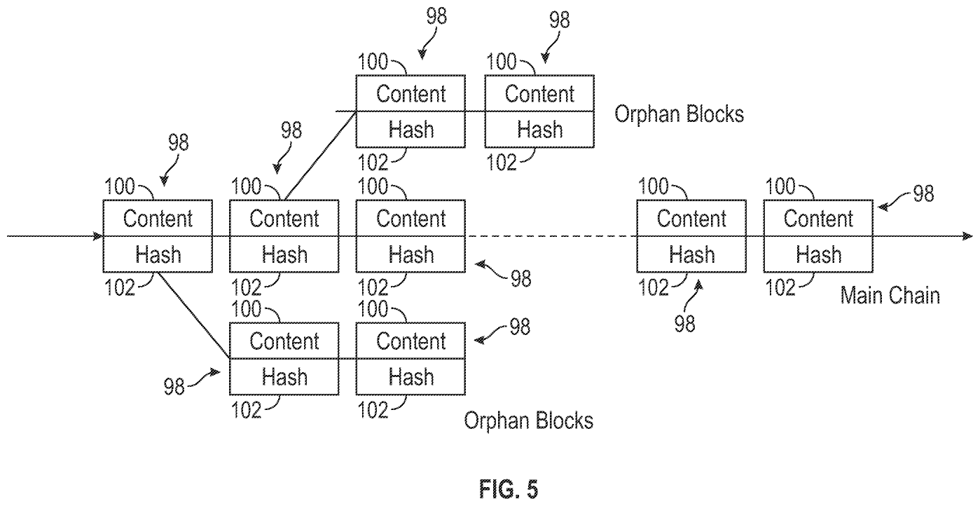

As illustrated in FIG. 4, in certain embodiments, each blockchain framework 84 may incorporate on a respective peer node 82 instances of a peer service 86, a software development kit (SDK) 88, an ordering service 90, and an oil and gas well intervention data storage service 92 to establish distributed oil and gas well intervention data within a standardized blockchain framework 84. The blockchain framework 84 may have access to a persistent datastore 94 including one or more blockchains 96. As illustrated in FIG. 5, each blockchain 96 may include a plurality of blocks 98, with each block 98 including content 100 and a hash 102. In addition, as also illustrated in FIG. 5, certain blocks 98 may form a main chain, whereas other blocks 98 may be orphan blocks.

Returning to FIG. 4, in certain embodiments, each peer service 86 may be configured as a service that stores transactions in the form of cryptographically hashed blocks 98, as well as storing smart contracts. Each peer service 86 instance may also be responsible for executing a smart contract on transactions to generate simulated results. Once a peer service 86 validates transactions, the peer service 86 may endorse those transactions by signing them. In addition, in certain embodiments, peer service 86 instances may be connected to one another over a network subnet referred to herein as a channel. In addition, in certain embodiments, peer service 86 instances may also function as committers (e.g., to commit transactions to a blockchain 96 once a new block 98 is received from an ordering service 90).

In certain embodiments, each application SDK 88 may function as a client library for developers that may be leveraged in order to perform transactions within a cloud-based collaboration system. In certain embodiments, each application SDK 88 may also implement various cryptographic algorithms for use in signing transactions on an application's behalf.

In certain embodiments, each ordering service 90 may be used to validate whether it has received endorsed results from all involved peers in the peer node 402, and further may be used to execute transactions once validation is completed. Thereafter, once the execution of a transaction is complete, the response may be sent back to application SDK 88 and a new block 98 may be generated using a cryptographic hash 102. This newly generated block 98 may then be broadcast to all peer nodes 82 in the channel.

In certain embodiments, each oil and gas well intervention data storage service 92 may be used to authenticate, authorize, and manage identities and channels. Every peer and application (e.g., of various data processing and control systems 42 and/or other computing systems 78) may enroll itself to the oil and gas well intervention data storage service 92, and in certain embodiments, multiple oil and gas well intervention data storage services 92 may run to reduce the risk of a single point of failure.

As described in greater detail herein, a plurality of different kinds of data relating to oil and gas well intervention operations may be collected and stored in a distributed blockchain network 48 by a data processing and control system 42 in substantially real time during the oil and gas well intervention operations. In certain embodiments, the oil and gas well intervention data may relate to various different types of operational parameters of an oil and gas well intervention operation 10. For example, as illustrated in FIG. 2, data relating to various operational parameters for both surface equipment 74 and downhole equipment 76 may be collected by the data processing and control system 42 and stored in a distributed blockchain network 48 in substantially real time during oil and gas well intervention operations performed by the oil and gas well intervention operation 10. In certain embodiments, different types of data (e.g., data relating to various operational parameters for surface equipment 74 versus data relating to various operational parameters for downhole equipment 76) may be converted to and/or from various data formats (e.g., based on different data formats used by the specific equipment 74, 76 and/or based on relative importance of the particular data types).

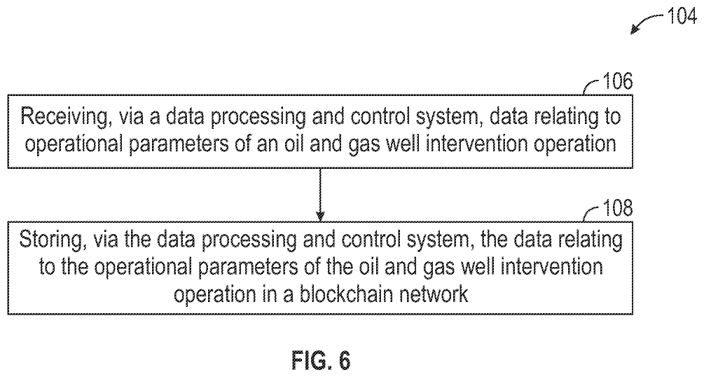

FIG. 6 is a flow diagram of a process 104 for operating the data processing and control system 42 described herein. As illustrated, in certain embodiments, the process 104 may include receiving, via the data processing and control system 42, data relating to operational parameters of an oil and gas well intervention operation (block 106). In addition, in certain embodiments, the process 104 may include storing, via the data processing and control system 42, the data relating to the operational parameters of the oil and gas well intervention operation in a blockchain network 48 (block 108).

In certain embodiments, the process 104 may include automatically adjusting, via the data processing and control system 42, one or more operational parameters of equipment 74, 76 performing the oil and gas well intervention operation based at least in part on data stored in the blockchain network 48. In certain embodiments, the data relating to the operational parameters of the oil and gas well intervention operation may include data relating to operational parameters of surface equipment 74. In addition, in certain embodiments, the data relating to the operational parameters of the oil and gas well intervention operation may include data relating to operational parameters of downhole equipment 76. In addition, in certain embodiments, the data relating to the operational parameters of the oil and gas well intervention operation may include data acquired by a fiber optic cable in coiled tubing 20 of the oil and gas well intervention operation.

In certain embodiments, the process 104 may include converting, via the data processing and control system 42, the data from a first data format to a second data format prior to storing the data in the blockchain network 48. In certain embodiments, the process 104 may include converting, via the data processing and control system 42, the data from the first data format to the second data format based at least in part on a type of equipment 74, 76 that collected the data. In addition, in certain embodiments, the process 104 may include converting, via the data processing and control system 42, the data from the first data format to the second data format based at least in part on a relative importance of the respective operational parameter.

According to certain embodiments of the present disclosure, a method includes receiving, via a data processing and control system, data relating to operational parameters of an oil and gas well intervention operation; and storing, via the data processing and control system, the data relating to the operational parameters of the oil and gas well intervention operation in a blockchain network. In certain embodiments, the method includes automatically adjusting, via the data processing and control system, one or more operational parameters of equipment performing the oil and gas well intervention operation based at least in part on data stored in the blockchain network. In certain embodiments, the data relating to the operational parameters of the oil and gas well intervention operation includes data relating to operational parameters of surface equipment. In certain embodiments, the data relating to the operational parameters of the oil and gas well intervention operation includes data relating to operational parameters of downhole equipment. In certain embodiments, the data relating to the operational parameters of the oil and gas well intervention operation includes data acquired by a fiber optic cable in coiled tubing of the oil and gas well intervention operation.

In certain embodiments, the method includes converting, via the data processing and control system, the data from a first data format to a second data format prior to storing the data in the blockchain network. In certain embodiments, the method includes converting, via the data processing and control system, the data from the first data format to the second data format based at least in part on a type of equipment that collected the data. In certain embodiments, the method includes converting, via the data processing and control system, the data from the first data format to the second data format based at least in part on a relative importance of a respective operational parameter.

In certain embodiments of the present disclosure, a system includes a data processing and control system configured to receive data relating to operational parameters of an oil and gas well intervention operation, and store the data relating to the operational parameters of the oil and gas well intervention operation in a blockchain network. In certain embodiments, the data processing and control system is configured to adjust one or more operational parameters of equipment performing the oil and gas well intervention operation based at least in part on data stored in the blockchain network. In certain embodiments, the data relating to the operational parameters of the oil and gas well intervention operation includes data relating to operational parameters of surface equipment. In certain embodiments, the data relating to the operational parameters of the oil and gas well intervention operation includes data relating to operational parameters of downhole equipment.

In certain embodiments, the data relating to the operational parameters of the oil and gas well intervention operation includes data acquired by a fiber optic cable in coiled tubing of the oil and gas well intervention operation. In certain embodiments, the data processing and control system is configured to convert the data from a first data format to a second data format prior to storing the data in the blockchain network. In certain embodiments, the data processing and control system is configured to convert the data from the first data format to the second data format based at least in part on a type of equipment that collected the data. In certain embodiments, the data processing and control system is configured to convert the data from the first data format to the second data format based at least in part on a relative importance of a respective operational parameter.

In certain embodiments of the present disclosure, a tangible, non-transitory, computer-readable media includes process-executable instructions that, when executed by one or more processors, cause the one or more processors to receive data relating to operational parameters of an oil and gas well intervention operation, and store the data relating to the operational parameters of the oil and gas well intervention operation in a blockchain network. In certain embodiments, the process-executable instructions, when executed by the one or more processors, cause the one or more processors to adjust the one or more operational parameters of equipment performing the oil and gas well intervention operation based at least in part on data stored in the blockchain network. In certain embodiments, the data relating to the operational parameters of the oil and gas well intervention operation includes data relating to operational parameters of surface equipment. In certain embodiments, the data relating to the operational parameters of the oil and gas well intervention operation includes data relating to operational parameters of downhole equipment. In certain embodiments, the data relating to the operational parameters of the oil and gas well intervention operation includes data acquired by a fiber optic cable in coiled tubing of the oil and gas well intervention.

In certain embodiments, the process-executable instructions, when executed by one or more processors, cause the one or more processors to convert the data from a first data format to a second data format prior to storing the data in the blockchain network. In certain embodiments, the process-executable instructions, when executed by one or more processors, cause the one or more processors to convert the data form the first data format to the second data format based at least in part on a type of equipment that collected the data. In certain embodiments, the process-executable instructions, when executed by one or more processors, cause the one or more processors to convert the data from the first data format to the second data format based at least in part on a relative importance of a respective operational parameter.

The specific embodiments described above have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A method, comprising:
receiving, via a data processing and control system, data relating to operational parameters of an oil and gas well intervention operation; and
storing, via the data processing and control system, the data relating to the operational parameters of the oil and gas well intervention operation in a blockchain network.

2. The method of claim 1, comprising automatically adjusting, via the data processing and control system, one or more operational parameters of equipment performing the oil and gas well intervention operation based at least in part on data stored in the blockchain network.

3. The method of claim 1, wherein the data relating to the operational parameters of the oil and gas well intervention operation comprises data relating to operational parameters of surface equipment.

4. The method of claim 1, wherein the data relating to the operational parameters of the oil and gas well intervention operation comprises data relating to operational parameters of downhole equipment.

5. The method of claim 1, wherein the data relating to the operational parameters of the oil and gas well intervention operation comprises data acquired by a fiber optic cable in coiled tubing of the oil and gas well intervention operation.

6. The method of claim 1, comprising converting, via the data processing and control system, the data from a first data format to a second data format prior to storing the data in the blockchain network.

7. The method of claim 6, comprising converting, via the data processing and control system, the data from the first data format to the second data format based at least in part on a type of equipment that collected the data.

8. The method of claim 6, comprising converting, via the data processing and control system, the data from the first data format to the second data format based at least in part on a relative importance of a respective operational parameter.

9. A system, comprising:
a data processing and control system configured to:
receive data relating to operational parameters of an oil and gas well intervention operation; and
store the data relating to the operational parameters of the oil and gas well intervention operation in a blockchain network.

10. The system of claim 9, wherein the data processing and control system is configured to adjust one or more operational parameters of equipment performing the oil and gas well intervention operation based at least in part on data stored in the blockchain network.

11. The system of claim 9, wherein the data relating to the operational parameters of the oil and gas well intervention operation comprises data relating to operational parameters of surface equipment.

12. The system of claim 9, wherein the data relating to the operational parameters of the oil and gas well intervention operation comprises data relating to operational parameters of downhole equipment.

13. The system of claim 9, wherein the data relating to the operational parameters of the oil and gas well intervention operation comprises data acquired by a fiber optic cable in coiled tubing of the oil and gas well intervention operation.

14. The system of claim 9, wherein the data processing and control system is configured to convert the data from a first data format to a second data format prior to storing the data in the blockchain network.

15. The system of claim 14, wherein the data processing and control system is configured to convert the data from the first data format to the second data format based at least in part on a type of equipment that collected the data.

16. The system of claim 14, wherein the data processing and control system is configured to convert the data from the first data format to the second data format based at least in part on a relative importance of a respective operational parameter.

17. A tangible, non-transitory, computer-readable media comprising process-executable instructions that, when executed by one or more processors, cause the one or more processors to:
receive data relating to operational parameters of an oil and gas well intervention operation; and
store the data relating to the operational parameters of the oil and gas well intervention operation in a blockchain network.

18. The tangible, non-transitory, computer-readable media of claim 17, wherein the process-executable instructions, when executed by the one or more processors, cause the one or more processors to adjust one or more operational parameters of equipment performing the oil and gas well intervention operation based at least in part on data stored in the blockchain network.

19. The tangible, non-transitory, computer-readable media of claim 17, wherein the data relating to the operational parameters of the oil and gas well intervention operation comprises data relating to operational parameters of surface equipment.

20. The tangible, non-transitory, computer-readable media of claim 17, wherein the data relating to the operational parameters of the oil and gas well intervention operation comprises data relating to operational parameters of downhole equipment.

21. The tangible, non-transitory, computer-readable media of claim 17, wherein the data relating to the operational parameters of the oil and gas well intervention operation comprises data acquired by a fiber optic cable in coiled tubing of the oil and gas well intervention.

22. The tangible, non-transitory, computer-readable media of claim 17, wherein the process-executable instructions, when executed by one or more processors, cause the one or more processors to convert the data from a first data format to a second data format prior to storing the data in the blockchain network.

23. The tangible, non-transitory, computer-readable media of claim 22, wherein the process-executable instructions, when executed by one or more processors, cause the one or more processors to convert the data from the first data format to the second data format based at least in part on a type of equipment that collected the data.

24. The tangible, non-transitory, computer-readable media of claim 22, wherein the process-executable instructions, when executed by one or more processors, cause the one or more processors to convert the data from the first data format to the second data format based at least in part on a relative importance of a respective operational parameter.
